(19) United States
(12) Patent Application Publication
(10) Pub. No.: US 2007/0136820 A1
(43) Pub. Date: Jun. 14, 2007

(54) SERVER APPARATUS, CLIENT APPARATUS, CONTROL METHOD THEREFOR, AND COMPUTER PROGRAM

(75) Inventor: Kentaro Saito, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/530,608

(22) Filed: Sep. 11, 2006

(30) Foreign Application Priority Data
Sep. 13, 2005 (JP) 2005-265937 (PAT.

(51) Int. Cl. H04L 9/32

(52) U.S. Cl. 726/27

(57) ABSTRACT

A server apparatus capable of communicating with a client apparatus via plurality of transmission paths includes a memory unit adapted to store first authentication information of the client apparatus which communicates via at least one of the plurality of transmission paths, a request unit adapted to request transmission of second authentication information stored in the memory unit of the client apparatus upon acceptance of a connection request from the client apparatus via one of the plurality of transmission paths, a first authentication unit adapted to authenticate the second authentication information on the basis of the first authentication information when the second authentication information is transmitted in response to the request, and an access permission unit adapted to permit access from the client apparatus when the first authentication unit authenticates the second authentication information.

### BACKGROUND OF THE INVENTION

1. Field of the Invention

The present invention relates to a server apparatus, client apparatus, control method therefor, and computer program.

2. Description of the Related Art

In the ubiquitous society, many devices cooperate with each other to provide user-friendly functions. To operate devices in cooperation with each other, they must comply with networks, and many devices are actually dealing with networks. Among these devices, a cellular phone, mobile terminal, notebook personal computer, and the like cope with two communication systems: short-range wireless communication (e.g., infrared communication or Bluetooth) and Internet communication.

Short-range wireless communication always permits devices to communicate with each other as far as they are close to each other even if they cannot connect to the Internet. In short-range wireless communication, a device can communicate with only a nearby device, so the existence of the device can be proved, preventing spoofing. To the contrary, Internet communication can transmit a large amount of data to a remote place at high speed. Since Internet communication and short-range wireless communication have different features and application purposes, devices having a plurality of communication systems will appear.

These days, to protect confidential information, many devices hold security schemes. As a simple example, in order to access any information, the user must input his user name and password. If authentication is successful, the user can acquire the information (see Japanese Patent Laid-Open No. 2002-140300).

At present, however, when the device has a plurality of communication systems, the user must execute authentication for each communication system in order to start communication. Although the user ensures security, user operability degrades.

In contrast to this, a system which exchanges data by one communication system between a server and a client can improve user operability by decreasing the authentication count. This can be achieved by authenticating a user only once and saving the result as a cookie in the client even when limiting access to each Web page.

When there is a plurality of communication systems, the server which performs authentication cannot identify whether requests come from the same device through different communication systems or whether a connection request comes from a device already authenticated by another system. The server issues authentication requests to access requests from different systems, impairing user operability.

### SUMMARY OF THE INVENTION

It is an object of the present invention to allow a device capable of accessing a server using different communication systems to apply the authentication result of one communication system to communication through another communication system, and thereby omit authentication in another communication system.

In order to solve the above problems, according to one aspect of preferred embodiments of the present invention, a server apparatus capable of communicating with a client apparatus via a plurality of communication paths, comprising, a memory unit adapted to store first authentication information of the client apparatus which communicates via at least one of the plurality of communication paths, a request unit adapted to request the client apparatus to transmit second authentication information stored in a memory unit of the client apparatus upon acceptance of an access request from the client apparatus via one of the plurality of communication paths, a first authentication unit adapted to authenticate the second authentication information on the basis of the first authentication information when the second authentication information is transmitted in response to the transmission request, and an access permission unit adapted to permit access from the client apparatus when the first authentication unit authenticates the second authentication information.

According to another aspect of preferred embodiments of the present invention, a server apparatus capable of communicating with a client apparatus via a plurality of communication paths, comprising, a memory unit adapted to store identification information and first authentication information of the client apparatus which communicates via at least one of the plurality of communication paths, a request unit adapted to request the client apparatus to transmit the identification information of the client apparatus upon acceptance of an access request from the client apparatus via one of the plurality of communication paths, a determination unit adapted to determine whether or not the memory unit stores the identification information transmitted in response to the transmission request, and an access permission unit adapted to permit access from the client apparatus when the determination unit determines that the memory unit stores the transmitted identification information.

According to further aspect of preferred embodiments of the present invention, a client apparatus capable of communicating with a server apparatus via a plurality of communication paths, comprising, a memory unit adapted to store authentication information received from the server apparatus which communicates via at least one of the plurality of communication paths, an access request unit adapted to request access to the server apparatus via a first communication path of the plurality of communication paths, and a transmission unit adapted to transmit, to the server apparatus in response to the access request, the authentication information requested by the server apparatus to be transmitted, wherein the client apparatus communicates with the server apparatus when access to the server apparatus is permitted on the basis of the authentication information transmitted from the transmission unit.

According to further aspect of preferred embodiments of the present invention, a client apparatus capable of communicating with a server apparatus via a plurality of communication paths, comprising, a memory unit adapted to store identification information of the client apparatus, an access request unit adapted to request access to the server apparatus via a first communication path of the plurality of transmission communication paths, and a transmission unit adapted to transmit, to the server apparatus in response to the access request, the identification information requested by the server apparatus to be transmitted, wherein the client apparatus communicates with the server apparatus when access to the server apparatus is permitted on the basis of the identification information transmitted from the transmission unit.

Further features of the present invention will become apparent from the following description of exemplary embodiments (with reference to the attached drawings).

### BRIEF DESCRIPTION OF THE DRAWINGS

FIG. 1 is a block diagram showing an example of a system configuration according to an embodiment of the present invention;

FIG. 2 is a view showing an example of an authentication window according to the embodiment of the present invention;

FIG. 3 is a view showing an example of the layout of an authentication ticket according to the embodiment of the present invention;

FIG. 4 is a flowchart of a process according to the first embodiment of the present invention;

FIG. 5 is a flowchart of an example of an authentication ticket authentication process in step S420 of FIG. 4;

FIG. 6 is a table showing an example of the format of a device ID management table according to the second embodiment of the present invention;

FIG. 7 is a flowchart of a process according to the second embodiment of the present invention;

FIG. 8 is a flowchart of a device ID management table update process according to the second embodiment of the present invention; and

FIG. 9 is a flowchart of a process according to the third embodiment of the present invention.

### DESCRIPTION OF THE EMBODIMENTS

### First Embodiment

In the first embodiment, when authentication is successful in one communication system in communication between devices each having two different communication systems, authentication in the other communication system becomes successful on the basis of authentication in the successful communication. For this purpose, the first embodiment introduces the concept of authentication information “authentication ticket”.

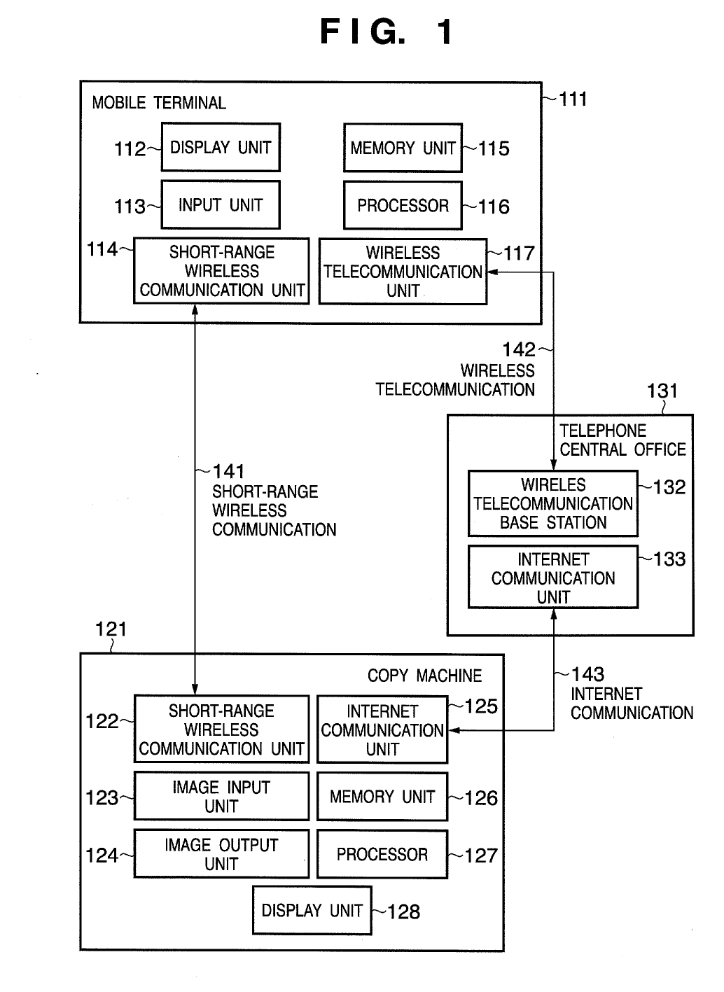

FIG. 1 is a block diagram showing an example of a system configuration according to the first embodiment. In FIG. 1, reference numeral 111 denotes a mobile terminal serving as a client apparatus. The mobile terminal 111 can perform communication using two communication systems: a short-range wireless communication unit 114 and wireless telecommunication unit 117. The mobile terminal 111 comprises a display unit 112 which displays an authentication window, an input unit 113 which inputs authentication information, and a memory unit 115 which stores an authentication ticket serving as authentication information issued from a copy machine 121 when authentication is successful. The mobile terminal 111 further comprises a processor 116 which controls a process to transmit an authentication ticket in response to an authentication request, a process to display an authentication window on the display unit 112, and an overall process in the mobile terminal 111. The memory unit 115 further stores a processing program for practicing the present invention.

The copy machine 121 serves as a server apparatus. The copy machine 121 can perform communication using two communication systems: a short-range wireless communication unit 122 and Internet communication unit 125. The copy machine 121 comprises a memory unit 126 which stores an authentication data table holding authentication data made up of a user name and password, and a processor 127 which controls a process to authenticate authentication data transmitted from the mobile terminal 111 on the basis of the authentication data table and a whole process in the copy machine 121. The copy machine 121 further comprises an image input unit 123, image output unit 124, and display unit 128. The memory unit 126 further stores a processing program for practicing the present invention.

Reference numeral 131 denotes a telephone central office which comprises a wireless telecommunication base station 132 and Internet communication unit 133. The telephone central office 131 can supply information received via radio waves in wireless telecommunication 142 to Internet communication 143, or transmit information received from the Internet communication 143 to the mobile terminal 111 via the wireless telecommunication 142.

In the first embodiment, the mobile terminal 111 and copy machine 121 can directly communicate with each other by short-range wireless communication 141 using the short-range wireless communication units 114 and 122, respectively. Further, the mobile terminal 111 and copy machine 121 can communicate with each other via the wireless telecommunication 142 and Internet communication 143 by the medium of the telephone central office 131 between the wireless telecommunication unit 117 of the mobile terminal 111 and the Internet communication unit 125 of the copy machine 121.

In the first embodiment, the mobile terminal 111 and copy machine 121 suffice to be devices capable of communicating with each other using two different communication systems, and these two systems are not always limited to wireless telecommunication and Internet communication. In other words, short-range wireless communication and wireless LAN may be combined. In wireless LAN, devices may directly communicate with each other without any intermediary station such as the telephone central office 131.

The copy machine 121 may request an authentication server (not shown in FIG. 1) serving as a device different from the copy machine 121, to authenticate a user name and password. The copy machine may determine the authentication result and issue an authentication ticket as authentication information.

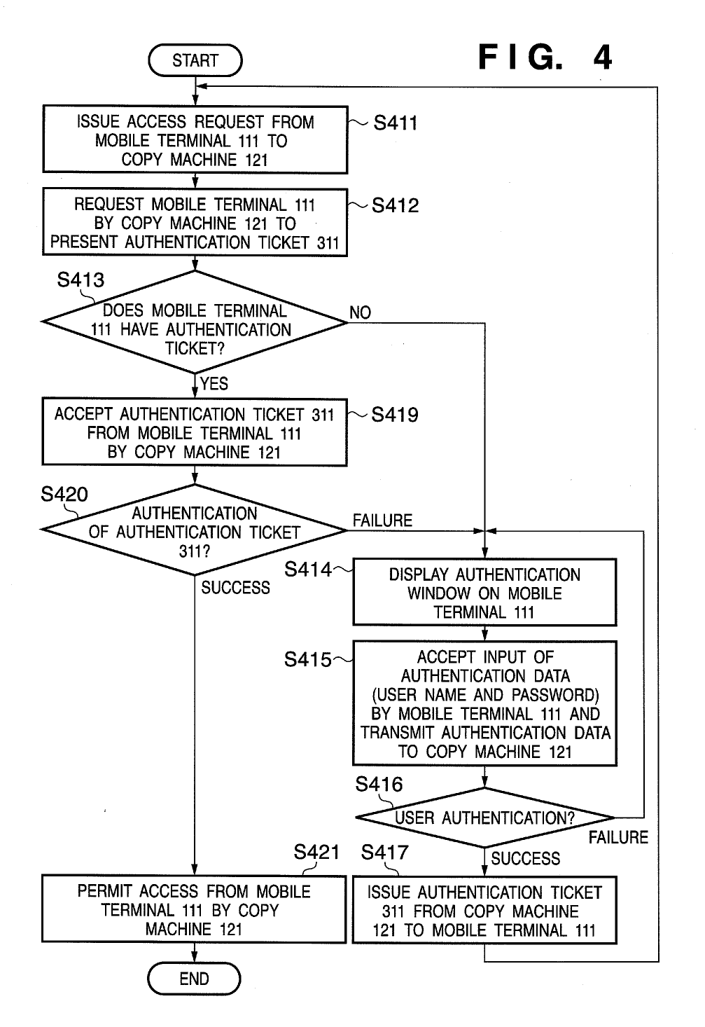

An example of an authentication process according to the first embodiment will be explained with reference to the flowchart of FIG. 4. In the first embodiment, the user may make access first by short-range wireless communication (e.g., Bluetooth or IrDA) and then by the Internet, or first by the Internet and then by short-range wireless communication.

In the process of FIG. 4, the mobile terminal 111 achieves its process by executing a corresponding processing program stored in the memory unit 115 by the processor 116. The copy machine 121 achieves its process by executing a corresponding processing program stored in the memory unit 126 by the processor 127.

In step S411 of FIG. 4, the mobile terminal 111 issues an access request to the copy machine 121. When the mobile terminal 111 issues an access request by the short-range wireless communication 141, the short-range wireless communication units 114 and 122 communicate with each other. When the mobile terminal 111 issues an access request by Internet communication (wireless telecommunication 142 and Internet communication 143), the wireless telecommunication unit 117 and Internet communication unit 125 communicate with each other via the wireless telecommunication base station 132 and Internet communication unit 133.

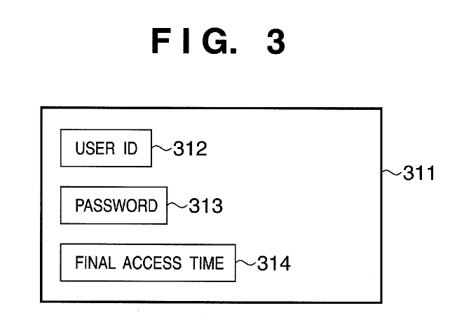

In step S412, the copy machine 121 requests the mobile terminal 111 to present an authentication ticket. An example of the authentication ticket will be explained with reference to FIG. 3. FIG. 3 is a view showing an example of the layout of the authentication information. In FIG. 3, reference numeral 311 denotes an entire authentication ticket. When authentication is successful between the mobile terminal 111 and the copy machine 121, the copy machine 121 generates the authentication ticket 311 and the memory unit 115 of the mobile terminal 111 stores the authentication ticket 311 as authentication information. The authentication ticket 311 has a user ID 312 serving as user identification information, a password 313, and final access time 314. The user ID 312 is information for uniquely identifying the user of the mobile terminal 111, and may be arbitrary information as far as the user ID 312 can discriminate the user of the mobile terminal 111 from another user. For example, the user ID 312 may be a user name arbitrarily set by the user, the telephone number of the mobile terminal 111, or the device ID of the mobile terminal.

The password 313 is information for uniquely identifying the mobile terminal 111 together with the user ID 312. The final access time 314 is the time when the mobile terminal 111 finally accesses an apparatus (in this example, the copy machine 121) which generated the authentication ticket. The final access time 314 is updated every time the mobile terminal 111 and copy machine 121 communicate with each other. The authentication ticket 311 allows setting the term of validity, and whether the authentication ticket 311 is valid can be determined from the time elapsed from the final access time 314. When the authentication ticket 311 does not have any term of validity (is free from any limitation), the authentication ticket 311 may not contain the final access time 314.

When authentication is necessary for each application used in the mobile terminal 111, the authentication ticket 311 may further have an application ID. In order to prevent tampering of the authentication ticket 311, the copy machine 121 may encrypt the authentication ticket 311 in a format which inhibits decryption by the mobile terminal 111 when transmitting the authentication ticket 311 to the mobile terminal 111. In this case, when receiving the authentication ticket 311 from the mobile terminal 111, the copy machine 121 decrypts the authentication ticket 311 to authenticate the mobile terminal 111.

The authentication data table stored in the memory unit 126 holds, for each user ID, pieces of information corresponding to at least the user ID 312, password 313, and final access time 314 in the authentication ticket 311.

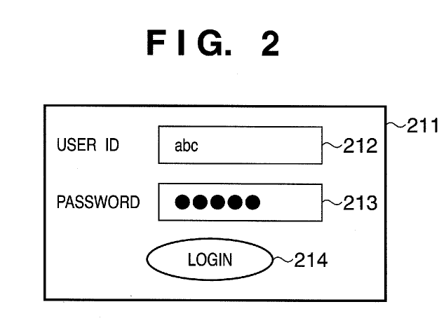

Referring back to FIG. 4, in step S413, the mobile terminal 111 determines whether the memory unit 115 stores the authentication ticket 311. If the memory unit 115 does not store the authentication ticket 311 (“NO” in step S413), the process shifts to step S414. In the first access to the copy machine 121, the mobile terminal 111 does not have the authentication ticket 311. Hence, the process shifts to step S414, and the display unit 112 of the mobile terminal 111 displays an authentication window. An example of the authentication window displayed at this time will be explained with reference to FIG. 2.

In FIG. 2, reference numeral 211 denotes an entire authentication window. The authentication window 211 displays a user ID input field 212, password input field 213, and login button 214. A user ID and password input in these input fields correspond to the user ID 312 and password 313 of the authentication ticket 311, respectively. Note that the user may input his biometrical authentication information such as the fingerprint, vein, iris, voice print, or face, instead of the password. In this case, a means for acquiring biometrical authentication information is necessary, but such a means is known well and a detailed description thereof will be omitted.

Referring back to FIG. 4, in step S415, the mobile terminal 111 accepts information input to the user ID input field 212 and password input field 213 by the user of the mobile terminal 111, and then accepts an operation to the login button 214. In accordance with the operation to the login button 214, the mobile terminal 111 transmits the input user ID 312 and password 313 to the copy machine 121.

In step S416, the copy machine 121 authenticates the user on the basis of the information transmitted from the mobile terminal 111. The copy machine 121 refers to authentication data registered in the authentication data table of the memory unit 126 and determines whether the authentication data table holds the transmitted user ID and password as authentication data. If the authentication data table holds the transmitted user ID and password (“success” in step S416), authentication is successful. In order to issue an authentication ticket, the process shifts to step S417. If the authentication data table does not hold the transmitted user ID and password (“failure” in step S416), authentication fails. In order to accept an input again, the process returns to step S414 and is repeated.

Note that not the copy machine 121 but an external authentication server may execute authentication in step S416, and the copy machine 121 may utilize the authentication result.

In step S417, the copy machine 121 generates the authentication ticket 311 on the basis of the user ID and password input by the user in step S415 and the time when the user input them, and transmits the authentication ticket 311 to the mobile terminal 111. In transmission, the copy machine 121 may encrypt the authentication ticket 311, or may add an digital signature in order to detect tampering. The copy machine 121 registers information (user ID, password, and time) corresponding to the generated authentication ticket 311 in the authentication data table of the memory unit 126. The mobile terminal 111 stores the authentication ticket 311 transmitted from the copy machine 121 in the memory unit 115. After step S417, the process returns to step S411.

After acquiring the authentication ticket 311, the mobile terminal 111 accesses the copy machine 121 again in step S411. In step S412, the copy machine 121 requests the authentication ticket 311 of the mobile terminal 111. At this time, the mobile terminal 111 has the authentication ticket 311 (“YES” in step S413), and transmits the authentication ticket 311 stored in the memory unit 115 to the copy machine 121. After that, the process shifts to step S419.

In step S419, the copy machine 121 receives the authentication ticket 311 from the mobile terminal 111. In step S420, the copy machine 121 authenticates the authentication ticket 311. The copy machine 121 can achieve this authentication by determining whether the user ID 312 and password 313 contained in the received authentication ticket 311 match pieces of information registered in the authentication data table. If the authentication data table does not hold matching information, authentication fails, and the process shifts to step S414. If the authentication data table holds matching information, authentication is successful, and the process shifts to step S421. When the authentication ticket 311 contains the final access time 314, the copy machine 121 may further determine based on the time whether the authentication ticket 311 has expired. If the copy machine 121 determines that the authentication ticket 311 has expired, authentication fails, and the process shifts to step S414. If the authentication ticket 311 does not expire, the copy machine 121 can determine that authentication is successful on condition that the authentication data table holds matching information.

In step S421, the copy machine 121 establishes the short-range wireless communication 141 with the mobile terminal 111 or the wireless telecommunication 142 and Internet communication 143, and permits access from the mobile terminal 111. As a result, the mobile terminal 111 can use the copy machine 121 to print an image and document data.

In the above description, after the copy machine 121 issues the authentication ticket 311 in step S417, the process returns to step S411, and the mobile terminal 111 accesses the copy machine 121 again and transmits the authentication ticket 311. However, the present invention is not limited to this process. The copy machine 121 may issue an authentication ticket in step S417 and then permit access in step S421.

As described above, in the first access to the copy machine 121, the mobile terminal 111 can acquire the authentication ticket 311 generated by the copy machine 121 regardless of which of the short-range wireless communication 141 and the Internet (wireless telecommunication 142 and Internet communication 143) is used. From the next access to the copy machine 121, the mobile terminal 111 transmits the acquired authentication ticket 311 to the copy machine 121 and can access the copy machine 121 while skipping the authentication process in steps S414 to S416 regardless of the communication system. This obviates the need for a user input in authentication.

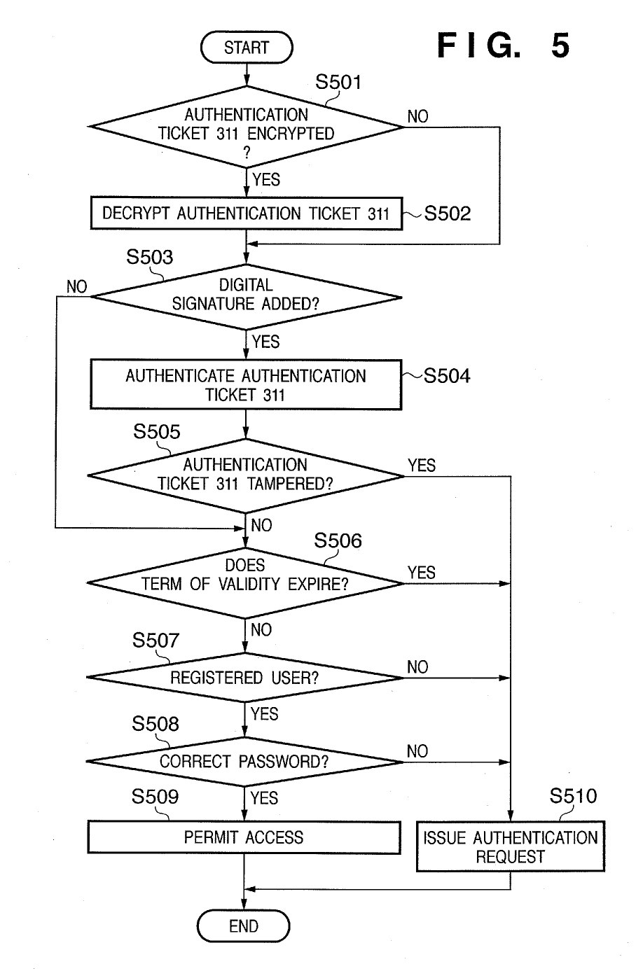

Details of the authentication process in step S420 in the flowchart of FIG. 4 will be explained with reference to the flowchart of FIG. 5.

In step S501, the copy machine 121 determines whether the authentication ticket 311 is encrypted. If the authentication ticket 311 is encrypted (“YES” in step S501), the process shifts to step S502, and the copy machine 121 decrypts the authentication ticket 311. In step S503, the copy machine 121 determines whether the transmitted authentication ticket 311 has an digital signature. If the authentication ticket 311 has an digital signature (“YES” in step S503), the process shifts to step S504. In step S504, the copy machine 121 decrypts the digital signature, generates the digest value of the authentication ticket 311, compares it with the decryption result of the digital signatures, and determines whether the authentication ticket 311 is tampered. If the copy machine 121 determines that the authentication ticket 311 is tampered (“YES” in step S505), the process shifts to step S510. If the copy machine 121 determines that the authentication ticket 311 is not tampered (“NO” in step S505), the process shifts to step S506. Also if the authentication ticket 311 does not have any digital signature (“NO” in step S503), the process shifts to step S506.

In step S506, the copy machine 121 determines whether the term of validity expires on the basis of the final access time 314 contained in the authentication ticket 311. The term of validity can be set to, e.g., one week or one month. If no term of validity is set, the process may skip step S506 and shift to step S507. If the copy machine 121 determines that the authentication ticket 311 expired (“YES” in step S506), the process shifts to step S510. If the copy machine 121 determines that the authentication ticket 311 does not expire (“NO” in step S506), the process shifts to step S507.

In step S507, the copy machine 121 determines whether the authentication data table in the memory unit 126 holds the user ID 312 of the authentication ticket 311. If the authentication data table holds the user ID 312 (“YES” in step S507), the process shifts to step S508. If the authentication data table does not hold the user ID 312 (“NO” in step S507), the process shifts to step S510.

In step S508, the copy machine 121 determines whether the password 313 of the authentication ticket 311 corresponds to the user ID 312 in the authentication data table of the memory unit 126. If the password 313 corresponds to the user ID 312 (“YES” in step S508), the process shifts to step S509, and the copy machine 121 determines “access permission”. If the password 313 does not correspond to the user ID 312 (“NO” in step S508), the process shifts to step S510. In step S510, the copy machine 121 determines whether to issue an “authentication request” to the mobile terminal 111.

If the copy machine 121 determines “access permission” in step S509, the process shifts to step S412 in FIG. 4. If the copy machine 121 determines an “authentication request” in step S510, the process shifts to step S414 in FIG. 4.

According to the first embodiment, a client can access a server via one of a plurality of communication systems, and apply an authentication result obtained by this access to another communication system in a system in which devices such as a mobile terminal and copy machine communicate with each other via a plurality of systems. A client authenticated by the server in short-range wireless communication can access the server via another communication system such as the Internet without taking the authentication procedure again, thus improving user operability.

An invention according to the first embodiment can be utilized in a case of customizing and using the operation unit of the copy machine 121 for each user. For example, the mobile terminal 111 can transmit operation unit information unique to a user to the copy machine 121 by short-range wireless communication, and can transmit large-size data such as print data to the copy machine 121 through the Internet. The user can set details of printing on a user-specific operation window displayed on the copy machine 121. Short-range wireless communication makes it possible to detect the distance between the copy machine 121 and the mobile terminal 111. When the user moves apart from the copy machine 121, the operation unit can return to its default display. When the copy machine 121 only displays user-specific operation unit information transmitted from the Internet without using short-range wireless communication, the settings may remain in the copy machine to degrade security.

In an invention according to the first embodiment, printing by Internet communication can use short-range wireless communication to confirm the print status, confirm a preview of a print material, or charge a user for printing. Printing can also adopt short-range wireless communication when the mobile terminal 111 acquires window information held in the copy machine 121 and the user operates the copy machine 121 from the mobile terminal 111 to print.

When infrared communication is used as short-range wireless communication, user authentication can be executed by infrared communication which can prevent spoofing and is almost free from wiretapping, and file exchange or the like can be done via the Internet without performing any authentication process. In the use of Bluetooth communication as short-range wireless communication, master and slave devices authenticate each other before entering the Bluetooth group. Devices within the group can perform file exchange or the like via the Internet without performing any authentication process.

### Second Embodiment

In the first embodiment, when a server apparatus successfully authenticates in either communication system a client apparatus having at least two communication systems, it issues the authentication ticket 311 and uses it for authentication in the other communication system. To the contrary, in the second embodiment, when the server apparatus successfully authenticates the client apparatus in one communication system, it authenticates it in the other communication system on the basis of the device ID of the client apparatus.

The system configuration in the second embodiment is also the same as that in the first embodiment, as shown in FIG. 1. In the second embodiment, a memory unit 115 of a mobile terminal 111 serving as a client apparatus stores the device ID of the mobile terminal 111. The device ID is an identification number uniquely assigned to each device, and allows uniquely discriminating the mobile terminal 111 from all other devices. A memory unit 126 of a copy machine 121 serving as a server apparatus stores a device ID management table for managing the device IDs of successfully authenticated client apparatuses.

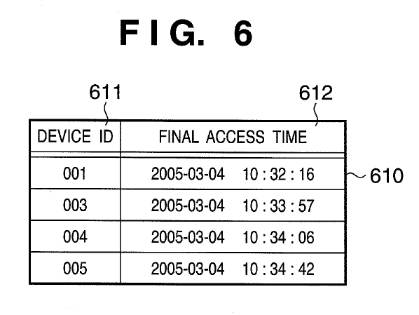

FIG. 6 is a table showing an example of the format of the device ID management table stored in the memory unit 126 of the copy machine 121.

A device ID management table 610 stores a pair of a device ID 611 and final access time 612 when a device having the device ID 611 accessed the copy machine 121.

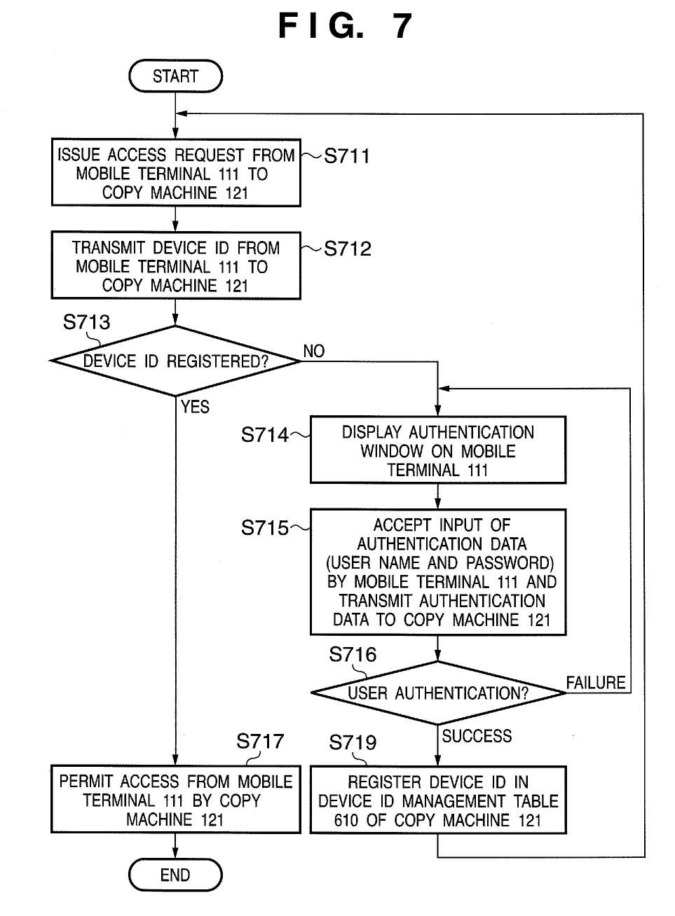

An authentication process according to the second embodiment will be explained with reference to FIG. 7. In the process of FIG. 7, the mobile terminal 111 achieves its process by executing a corresponding processing program stored in the memory unit 115 by a processor 116. The copy machine 121 achieves its process by executing a corresponding processing program stored in the memory unit 126 by a processor 127.

In step S711 of FIG. 7, the mobile terminal 111 issues an access request to the copy machine 121. When the mobile terminal 111 issues an access request by short-range wireless communication 141, short-range wireless communication units 114 and 122 communicate with each other. When the mobile terminal 111 issues an access request by Internet communication (wireless telecommunication 142 and Internet communication 143), a wireless telecommunication unit 117 and Internet communication unit 125 communicate with each other via a wireless telecommunication base station 132 and Internet communication unit 133.

In step S712, the mobile terminal 111 transmits its device ID stored in the memory unit 115 to the copy machine 121. In step S713, the copy machine 121 determines whether it holds the received device ID. More specifically, the copy machine 121 determines whether the device ID management table 610 in the memory unit 126 holds the received device ID. If the copy machine 121 determines that the device ID management table 610 holds the device ID (“YES” in step S713), the process shifts to step S717. In step S717, the copy machine 121 permits the mobile terminal 111 to access it. If the copy machine 121 determines that the device ID management table 610 does not hold the device ID (“NO” in step S713), the process shifts to step S714.

In step S714, a display unit 112 of the mobile terminal 111 displays an authentication window 211 as shown in FIG. 2. In step S715, the user of the mobile terminal 111 inputs a user ID and password into a user ID input field 212 and password input field 213, respectively, and the mobile terminal 111 transmits the pieces of input information to the copy machine 121. In step S716, the copy machine 121 authenticates the user on the basis of the received user ID and password.

More specifically, the copy machine 121 refers to contents registered in the authentication data table of the memory unit 126, and determines whether the authentication data table holds a pair of a matching user ID and password. If the authentication data table holds a matching pair (“success” in step S716), authentication is successful. Then, the process shifts to step S719, and the copy machine 121 registers the device ID of the mobile terminal 111 in the device ID management table 610, and registers the current time in the final access time 612. If the authentication data table does not hold any matching pair (“failure” in step S716), authentication fails. The process returns to step S714 and is repeated.

Note that not the copy machine 121 but an external authentication server may execute authentication in step S716, and the copy machine 121 may utilize the authentication result.

After step S719, the process returns to step S711, and the mobile terminal 111 attempts to access the copy machine 121 again. As another form, the process may shift to step S717 directly after step S719, and the copy machine 121 may permit the mobile terminal 111 to access it.

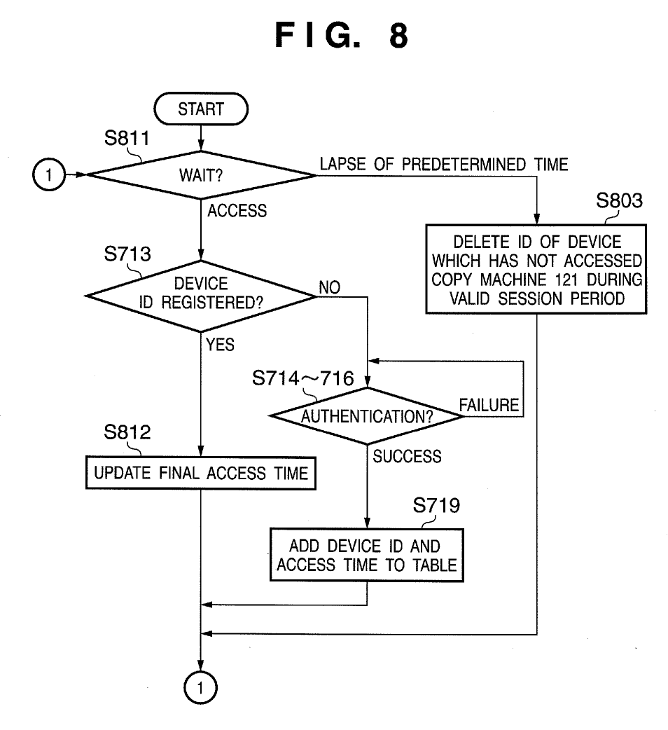

A process to update the device ID management table 610 by the copy machine 121 will be described with reference to FIG. 8. Since the update process proceeds parallel to part of the authentication process in FIG. 7, the same reference numerals as in FIG. 7 denote processes corresponding to FIG. 7. In the second embodiment, the copy machine 121 updates the device ID management table 610 upon access from the mobile terminal 111 and upon the lapse of a predetermined time.

In step S811 of FIG. 8, the copy machine 121 waits while monitoring access from the mobile terminal 111 or the lapse of a predetermined time. If the mobile terminal 111 attempts to access the copy machine 121 (“access” in step S811), the copy machine 121 performs the process in step S713. If the copy machine 121 determines that the device ID management table 610 holds a device ID from the mobile terminal 111 (“YES” in step S713), the process shifts to step S812. In step S812, the copy machine 121 updates the final access time 612 to the current time in the device ID management table 610. Thereafter, the process returns to step S811 and waits.

If the copy machine 121 determines in step S713 that the device ID management table 610 does not hold the device ID (“NO” in step S713), the copy machine 121 executes the authentication process in steps S714 to S716. If authentication is successful (“success” in step S716), the copy machine 121 executes step S719, and then the process returns to step S811.

In step S811, if the client apparatus does not access the copy machine 121 even upon the lapse of a predetermined time, the process shifts to step S813. In step S813, the copy machine 121 deletes registration of the client apparatus which has not accessed the copy machine 121 even after the term of validity, on the basis of the final access time 612 in the device ID management table 610. That is, the copy machine 121 deletes the device ID 611 and final access time 612 from the device ID management table 610. After that, the process returns to step S811 and continues.

As described above, according to the second embodiment, the server can apply the device ID of a client permitted to access the server in one of a plurality of communication systems, to authentication of access in another communication system. The second embodiment obviates the need to generate the authentication ticket 311 and save it in the client. The second embodiment can improve user operability and more efficiently execute the authentication process.

### Third Embodiment

In the first and second embodiments, only the mobile terminal serving as a client apparatus displays the authentication window 211. On the contrary, in the third embodiment, both the display unit of the mobile terminal serving as a client apparatus and that of the copy machine serving as a server apparatus display an authentication window 211 to allow performing an authentication process on the authentication window 211 on either display unit.

The system configuration in the third embodiment is also the same as those in the first and second embodiments, as shown in FIG. 1.

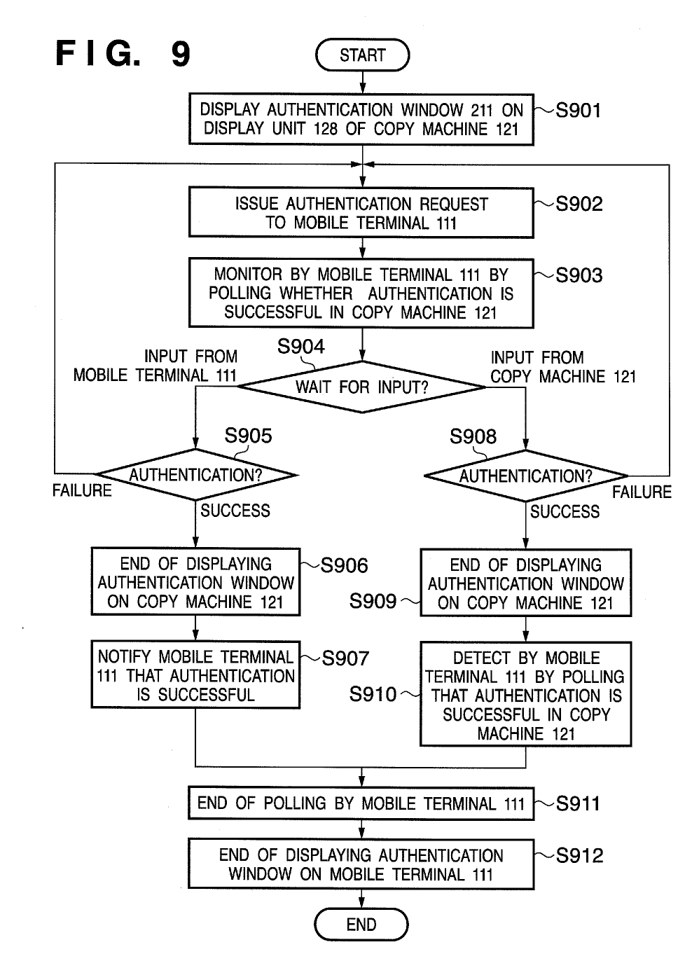

FIG. 9 is a flowchart of a process in the third embodiment as a modification of steps S414 to S416 in the first embodiment or steps S714 to S716 in the second embodiment. An authentication process in the third embodiment will be explained with reference to FIG. 9. In the process of FIG. 9, a mobile terminal 111 achieves its process by executing a corresponding processing program stored in a memory unit 115 by a processor 116. A copy machine 121 achieves its process by executing a corresponding processing program stored in a memory unit 126 by a processor 127.

In step S901, a display unit 128 of the copy machine 121 displays an authentication window 211 shown in FIG. 2. The user can utilize the copy machine 121 if he inputs his user ID and password to the authentication window 211 and is successfully authenticated. In step S902, the copy machine 121 issues an authentication request to the mobile terminal 111, and the mobile terminal 111 displays the authentication window 211 in FIG. 2 on a display unit 112. In step S903, the mobile terminal 111 starts monitoring by polling whether authentication is successful in the copy machine 121. In step S904, the copy machine 121 waits while monitoring whether the user inputs authentication data (user ID and password) to the mobile terminal 111 or copy machine 121.

If the user inputs authentication data to the mobile terminal 111 (“input from the mobile terminal 111” in step S904), the process shifts to step S905, and the copy machine 121 authenticates the authentication data input from the mobile terminal 111. If authentication fails (“failure” in step S905), the process returns to step S902. If authentication is successful (“success” in step S905), the process advances to step S906, and the copy machine 121 ends the display of the authentication window 211 on the display unit 128, and shifts to an operable state. In step S907, the copy machine 121 notifies the mobile terminal 111 that authentication is successful. Then, the process shifts to step S911.

If the user inputs authentication data to the copy machine 121 (“input from the copy machine 121” in step S904), the process shifts to step S908, and the copy machine 121 authenticates the authentication data input to the copy machine 121. If authentication fails (“failure” in step S908), the process returns to step S902. If authentication is successful (“success” in step S908), the process advances to step S909, and the copy machine 121 ends the display of the authentication window 211 on the display unit 128, and shifts to an operable state. In step S910, the mobile terminal 111 detects by polling that authentication is successful in the copy machine 121. Thereafter, the process shifts to step S911.

After recognizing successful authentication in the copy machine 121, the mobile terminal 111 ends polling in step S911. In step S912, the mobile terminal 111 ends the display of the authentication window 211 on the display unit 112.

By the above process, authentication in step S416 of FIG. 4 or step S716 of FIG. 7 ends.

Note that the above process branches to different destinations between a case of accepting input of authentication data from the mobile terminal 111 in step S904 and a case of accepting input of authentication data from the copy machine 121. However, the present invention is not limited to this, and the process may branch to step S908 regardless of which of the mobile terminal and copy machine 121 receives authentication data.

As described above, when simultaneously operating a plurality of devices, the user can close the authentication windows 211 on all the devices by one authentication process, and need not input authentication data to each device. This can further improve user operability.

### Other Embodiment

Note that the present invention may be applied to a system including a plurality of devices (e.g., a host computer, interface device, reader, and printer), or an apparatus having a single device (e.g., a copy machine or facsimile apparatus).

The objects of the present invention are also achieved by supplying a storage medium which records program codes of software that implements the above-described functions to the system, and reading out and executing the program codes by the system. In this case, the program codes read out from the storage medium implement the functions of the above-described embodiments, and the storage medium which stores the program codes constitutes the present invention. The present invention also includes a case where an operating system (OS) or the like running on the computer performs some or all of actual processes on the basis of the instructions of the program codes and thereby implements the functions of the above-described embodiments.

Furthermore, the present invention may be implemented by the following form. More specifically, the program codes read out from the storage medium are written in the memory of a function expansion card inserted into the computer or the memory of a function expansion unit connected to the computer. The CPU of the function expansion card or function expansion unit performs some or all of actual processes on the basis of the instructions of the program codes and thereby implements the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-265937, filed on Sep. 13, 2005, which is hereby incorporated by reference herein in its entirety.

What is claimed is:

1. A server apparatus capable of communicating with a client apparatus via a plurality of communication paths, comprising:
a memory unit adapted to store first authentication information of the client apparatus which communicates via at least one of the plurality of communication paths;
a request unit adapted to request the client apparatus to transmit second authentication information stored in a memory unit of the client apparatus upon acceptance of an access request from the client apparatus via one of the plurality of communication paths;
a first authentication unit adapted to authenticate the second authentication information on the basis of the first authentication information when the second authentication information is transmitted in response to the transmission request; and
an access permission unit adapted to permit access from the client apparatus when said first authentication unit authenticates the second authentication information.

2. The apparatus according to claim 1, further comprising:
a display control unit adapted to cause the client apparatus to display a first input window for inputting third authentication information when the second authentication information is not transmitted in accordance with the transmission request or when said first authentication unit does not authenticate the second authentication information;
a reception unit adapted to receive the third authentication information input using the first input window from the client apparatus;
a second authentication unit adapted to authenticate the third authentication information on the basis of the first authentication information; and
a transmission unit adapted to generate the second authentication information and transmit the second authentication information to the client apparatus when said second authentication unit authenticates the third authentication information.

3. The apparatus according to claim 2, wherein
said display control unit causes a display unit of the server apparatus to further display a second input window corresponding to the first input window,
said second authentication unit authenticates one of the third authentication information input using the first input window and fourth authentication information input using the second input window on the basis of the first authentication information, and
said display control unit ends display of the second input window when said second authentication unit performs authentication.

4. The apparatus according to claim 1, wherein
the second authentication information contains time information regarding when the client apparatus finally accessed the server apparatus, and
said first authentication unit does not authenticate the second authentication information upon lapse of a predetermined period of time from the time information.

5. A server apparatus capable of communicating with a client apparatus via a plurality of communication paths, comprising:
a memory unit adapted to store identification information and first authentication information of the client apparatus which communicates via at least one of the plurality of communication paths;
a request unit adapted to request the client apparatus to transmit the identification information of the client apparatus upon acceptance of an access request from the client apparatus via one of the plurality of communication paths;
a determination unit adapted to determine whether or not said memory unit stores the identification information transmitted in response to the transmission request; and
an access permission unit adapted to permit access from the client apparatus when said determination unit determines that said memory unit stores the transmitted identification information.

6. The apparatus according to claim 5, further comprising:
a display control unit adapted to cause the client apparatus to display a first input window for inputting second authentication information when said determination unit determines that said memory unit does not store the transmitted identification information;
a reception unit adapted to receive the second authentication information input using the first input window; and
an authentication unit adapted to authenticate the second authentication information on the basis of the first authentication information,
wherein when said authentication unit authenticates the second authentication information, said memory unit stores the transmitted identification information.

7. The apparatus according to claim 6, wherein
said display control unit causes a display unit of the server apparatus to further display a second input window corresponding to the first input window,
said authentication unit authenticates one of the second authentication information input using the first input window and third authentication information input using the second input window on the basis of the first authentication information, and
said display control unit ends display of the second input window when said authentication unit performs authentication.

8. The apparatus according to claim 5, wherein
said memory unit stores, in association with the identification information of the client apparatus, time information regarding when the client apparatus finally accessed the server apparatus,
said determination unit updates the time information when determining that said memory unit stores the transmitted identification information, and
the identification information is deleted from said memory unit upon lapse of a predetermined period of time from the time information.

9. The apparatus according to claim 1, wherein the authentication information contains user identification information and password of the client apparatus.

10. A client apparatus capable of communicating with a server apparatus via a plurality of communication paths, comprising:
a memory unit adapted to store authentication information received from the server apparatus which communicates via at least one of the plurality of communication paths;
an access request unit adapted to request access to the server apparatus via a first communication path of the plurality of communication paths; and
a transmission unit adapted to transmit, to the server apparatus in response to the access request, the authentication information requested by the server apparatus to be transmitted,
wherein the client apparatus communicates with the server apparatus when access to the server apparatus is permitted on the basis of the authentication information transmitted from said transmission unit.

11. The apparatus according to claim 10, further comprising a display control unit adapted to cause a display unit to display a first input window for accepting input of the authentication information when said memory unit does not store the authentication information or when access to the server apparatus is not permitted on the basis of the transmitted authentication information,
wherein said transmission unit transmits the authentication information input using the first input window to the server apparatus, and
the client apparatus communicates with the server apparatus when access to the server apparatus is permitted on the basis of the authentication information transmitted from said transmission unit.

12. The apparatus according to claim 11, wherein
the first communication path includes a short-range wireless communication path,
a display unit of the server apparatus displays a second input window corresponding to the first input window,
the client apparatus further comprises a detection unit adapted to detect an authentication result in the server apparatus for the authentication information input using one of the first input window and the second input window, and
said display control unit ends display of the first input window when the authentication result represents that the authentication information is authenticated.

13. A client apparatus capable of communicating with a server apparatus via a plurality of communication paths, comprising:
a memory unit adapted to store identification information of the client apparatus;
an access request unit adapted to request access to the server apparatus via a first communication path of the plurality of transmission communication paths; and
a transmission unit adapted to transmit, to the server apparatus in response to the access request, the identification information requested by the server apparatus to be transmitted,
wherein the client apparatus communicates with the server apparatus when access to the server apparatus is permitted on the basis of the identification information transmitted from said transmission unit.

14. The apparatus according to claim 13, further comprising a display control unit adapted to cause a display unit to display a first input window for accepting input of authentication information of the client apparatus when access to the server apparatus is not permitted on the basis of the identification information transmitted from said transmission unit,
wherein said transmission unit transmits the authentication information input using the first input window to the server apparatus, and
the client apparatus communicates with the server apparatus when access to the server apparatus is permitted on the basis of the authentication information transmitted from said transmission unit.

15. The apparatus according to claim 14, wherein
the first communication path includes a short-range wireless communication path,
a display unit of the server apparatus displays a second input window corresponding to the first input window,
the client apparatus further comprises a detection unit adapted to detect an authentication result in the server apparatus for the authentication information input using one of the first input window and the second input window, and
said display control unit ends display of the first input window when the authentication result represents that the authentication information is authenticated.

16. A computer program which is stored in a computer-readable storage medium and causes a computer to function as a server apparatus defined in claim 1.

17. A computer program which is stored in a computer-readable storage medium and causes a computer to function as a client apparatus defined in claim 10.

18. A method of controlling a server apparatus which can communicate with a client apparatus via a plurality of communication paths and has a memory unit adapted to store first authentication information of the client apparatus which communicates via at least one of the plurality of communication paths, said method comprising:
a request step of requesting the client apparatus to transmit second authentication information stored in a memory unit of the client apparatus upon acceptance of a connection request from the client apparatus via one of the plurality of communication paths;
a first authentication step of authenticating the second authentication information on the basis of the first authentication information when the second authentication information is transmitted in response to the transmission request; and
an access permission step of permitting access from the client apparatus when the second authentication information is authenticated in the first authentication step.

19. A method of controlling a server apparatus which can communicate with a client apparatus via a plurality of communication paths and has a memory unit adapted to store identification information and first authentication information of the client apparatus which communicates via at least one of the plurality of communication paths, said method comprising:
a request step of requesting the client apparatus to transmit the identification information of the client apparatus upon acceptance of a connection request from the client apparatus via one of the plurality of communication paths;
a determination step of determining whether the memory unit stores the identification information transmitted in response to the transmission request; and
an access permission step of permitting access from the client apparatus when the memory unit stores is determined in the determination step to store the transmitted identification information.

20. A method of controlling a client apparatus which can communicate with a server apparatus via a plurality of communication paths and has a memory unit adapted to store authentication information received from the server apparatus which communicates via at least one of the plurality of communication paths, comprising:
an access request step of requesting access to the server apparatus via a first communication path of the plurality of communication paths; and
a transmission step of transmitting, to the server apparatus in response to the access request, the authentication information requested by the server apparatus to be transmitted,
wherein the client apparatus communicates with the server apparatus when access to the server apparatus is permitted on the basis of the authentication information transmitted in the transmission step.

21. A method of controlling a client apparatus which can communicate with a server apparatus via a plurality of transmission paths and has a memory unit adapted to store identification information of the client apparatus, comprising:
an access request step of requesting access to the server apparatus via a first transmission path of the plurality of transmission paths; and
a transmission step of transmitting, to the server apparatus in response to the access request, the identification information requested by the server apparatus to be transmitted,
wherein the client apparatus communicates with the server apparatus when access to the server apparatus is permitted on the basis of the identification information transmitted in the transmission step.
